(19) United States
(12) Patent Application Publication
(10) Pub. No.: US 2010/0229681 A1
(43) Pub. Date: Sep. 16, 2010

(54) CONTINUOUSLY VARIABLE TRANSMISSION

(76) Inventors: Dong min Shin, Incheon (KR); Yong chol Chin, Incheon (KR)

Correspondence Address: BOYLE FREDRICKSON S.C., 840 North Plankinton Avenue, MILWAUKEE, WI, 53203, US

(21) Appl. No.: 12/376,328

(22) PCT Filed: Oct. 12, 2007
(86) PCT No.: PCT/KR07/04990

§ 371 Date: Feb. 4, 2009

(30) Foreign Application Priority Data
Nov. 22, 2006 (KR) 10-2006-0115606

(51) Int. Cl. F16H 29/18

(52) U.S. Cl. 74/837

(57) ABSTRACT

Disclosed is a continuously variable transmission. The continuously variable transmission includes a housing to which an input shaft is rotatably mounted to input power, an output section outputting the power transferred from the input shaft to the outside or receiving a load from outside, a torque change section provided between the input shaft and the output section to change the torque of the power transferred from the input shaft or the output section, and a link device disposed between the output section and the torque change section and eccentrically connected to the torque change section to transfer rotational power to the output section or receive a load from the output section by upward and downward reciprocal movements thereof.

### BACKGROUND OF THE INVENTION

1. Field of the Invention

The present invention relates to a continuously variable transmission, and more particularly to a continuously variable transmission capable of automatically increasing or decreasing an instantaneous torque output as a load applied to an output shaft increases or decreases.

2. Description of the Related Art

However, although the reduction gear unit outputs a torque by reducing the number of rotations supplied from the power generating unit and increasing the torque, when the load applied to the output shaft is higher than the output torque of the output shaft, the load is reversely applied to the motor or the engine, shortening the life span of the motor or the engine.

If a load higher than the output torque of the output shaft is reversely applied to the motor or the engine, an intended output cannot be supplied to the output shaft.

### SUMMARY OF THE INVENTION

Therefore, the present invention has been made in view of the above problems, and it is an aspect of the present invention to provide a continuously variable transmission capable of preventing a load of an output shaft from being transferred to a power source even when the load of the output shaft is increased by automatically increasing or decreasing the torque of the output shaft according to the load applied to the output shaft.

It is another aspect of the present invention to provide a continuously variable transmission capable of performing a drive operation at a constant speed in the case of an overload or a non-load by preventing an increase or decrease on the load applied to an output shaft from being transferred to a power generating unit.

In accordance with an aspect of the present invention, the above and other objects can be accomplished by the provision of a continuously variable transmission comprising: a housing to which an input shaft is rotatably mounted to input power; an output section outputting the power transferred from the input shaft to the outside or receiving a load from outside; a torque change section provided between the input shaft and the output section to change the torque of the power transferred from the input shaft or the output section; and a link device disposed between the output section and the torque change section and eccentrically connected to the torque change section to transfer rotational power to the output section or receive a load from the output section by upward and downward reciprocal movements thereof.

The continuously variable transmission can protect a power source by preventing a load of an output shaft from being transferred to the power source by automatically increasing or decreasing the torque of the output shaft according to the load applied to the output shaft.

The continuously variable transmission can also perform a drive operation at a constant speed even in the case of an overload or a non-load by preventing an increase or decrease on the load applied to an output shaft from being transferred to a power generating unit.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a continuously variable transmission according to an embodiment of the present invention;

FIG. 2 is a perspective view illustrating the continuously variable transmission of FIG. 1 in which an output plate is separated from a housing;

FIG. 3 is a perspective view illustrating the continuously variable transmission of FIG. 1 in which an input plate is separated from the housing;

FIG. 4 is an exploded perspective view of the continuously variable transmission of FIG. 1;

FIG. 5 is a perspective view of the continuously variable transmission of FIG. 1 from which the housing is separated;

FIG. 6 is a perspective view of the continuously variable transmission of FIG. 1 viewed from the lower side;

FIG. 7 is an exploded view of the continuously variable transmission of FIG. 5;

FIG. 8 is a front view of the continuously variable transmission of FIG. 5;

FIG. 9 is a right side view of the continuously variable transmission of FIG. 5;

FIG. 10 is a left side view of the continuously variable transmission of FIG. 5;

FIG. 11 is a perspective view illustrating a lever crank of the continuously variable transmission of FIG. 5;

FIG. 12 is a perspective view illustrating a drive body of the continuously variable transmission of FIG. 5;

FIG. 13 is an exploded perspective view of the drive body of FIG. 12;

FIG. 14 is a cross-sectional view of the drive body of FIG. 12 taken along line I-I;

FIG. 15 is an operational view of the lever crank of FIG. 11;

FIG. 16 is an operational view for forward and reverse conversion of the continuously variable transmission of FIG. 5;

FIG. 17 is a side view illustrating a resilient member resiliently supporting a pressing device of the continuously variable transmission of FIG. 5;

FIG. 18 is a schematic view illustrating a continuously variable transmission according another embodiment of the present invention;

FIG. 19 is a front view of the continuously variable transmission illustrated in FIG. 18;

FIG. 20 is a front view of the continuously variable transmission of FIG. 18 from which a rotational inertia regulating device is separated;

FIG. 21 is a plan view of the continuously variable transmission of FIG. 19;

FIG. 22 is a left side view of the continuously variable transmission of FIG. 19;

FIG. 23 is a left side view illustrating a torque change section of the continuously variable transmission of FIG. 19; and

FIG. 24 is a longitudinal cross-sectional view illustrating a power generating section of the continuously variable transmission of FIG. 19.

### DETAILED DESCRIPTION OF THE PREFERRED EMBODIMENT

Hereinafter, continuously variable transmissions according to preferred embodiments of the present invention will be described in detail with reference to the accompanying drawings.

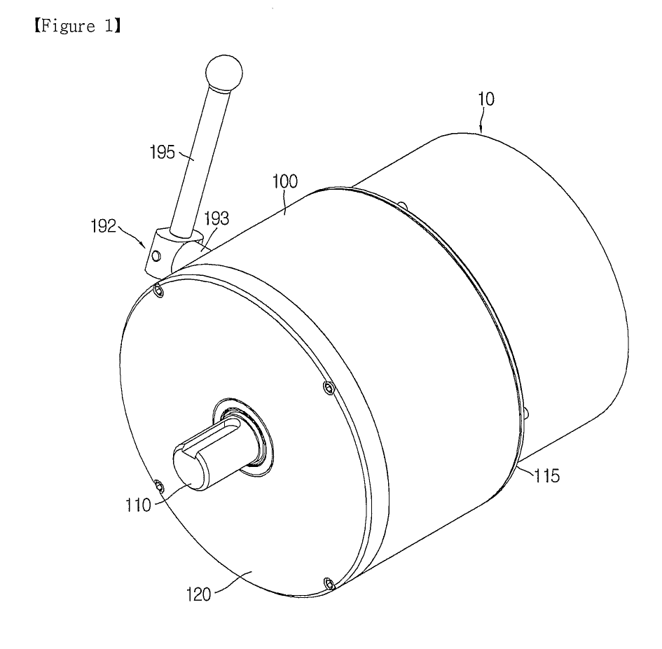

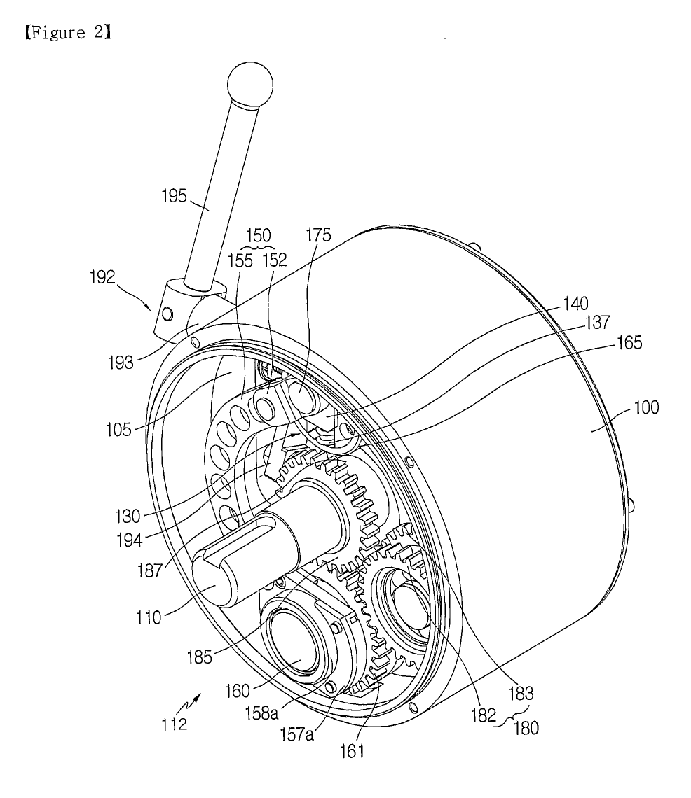

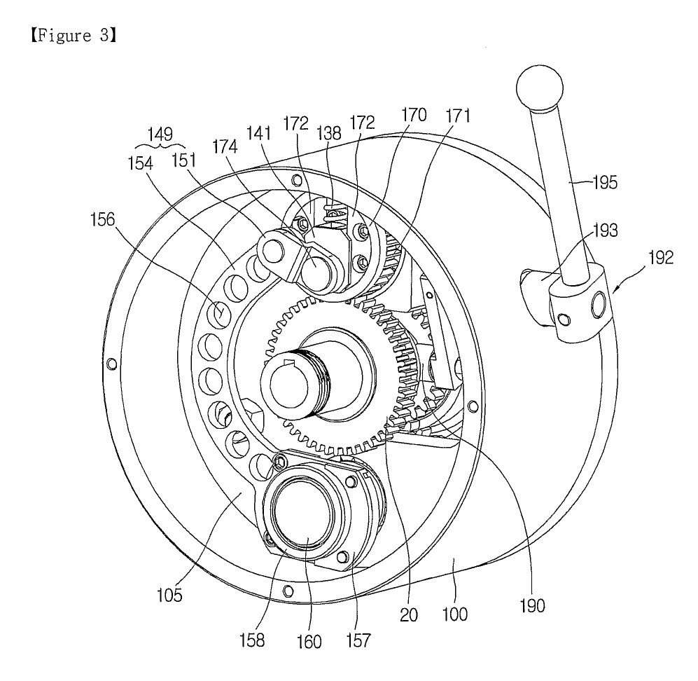

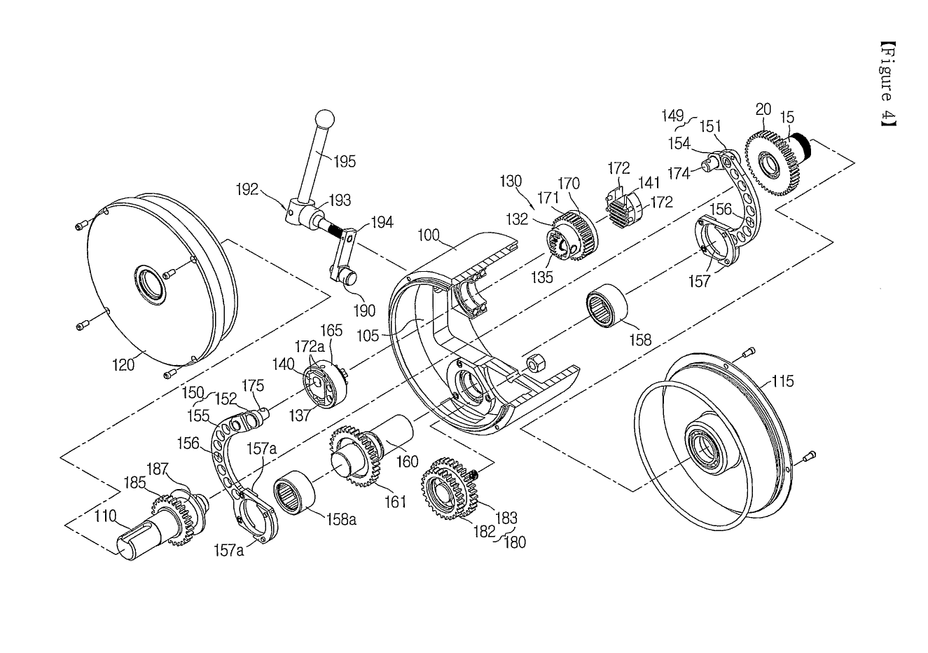

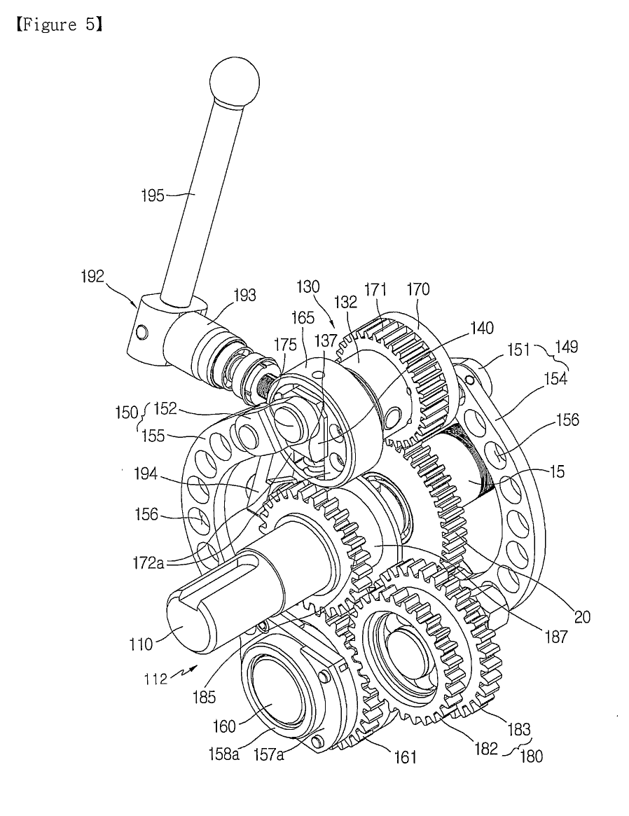

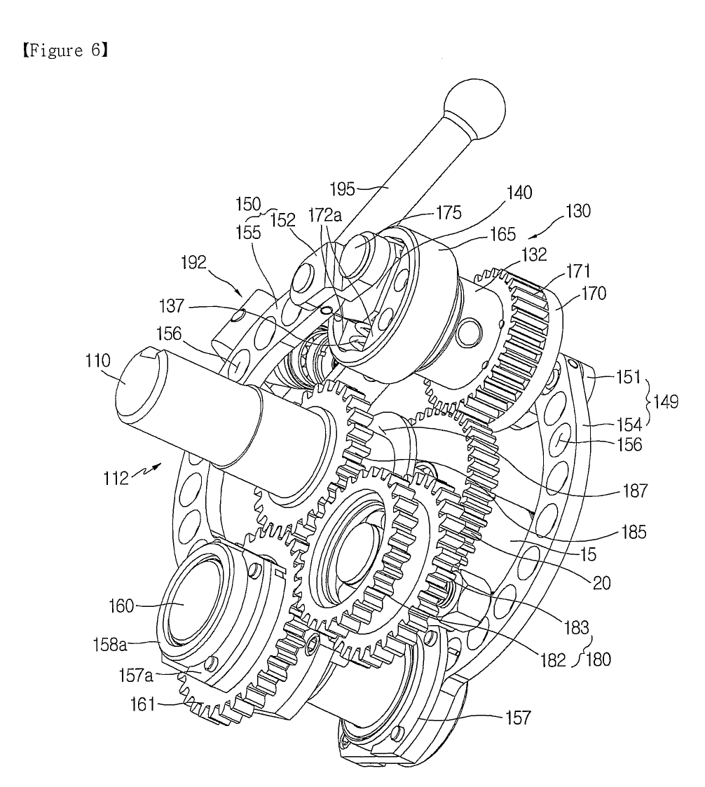

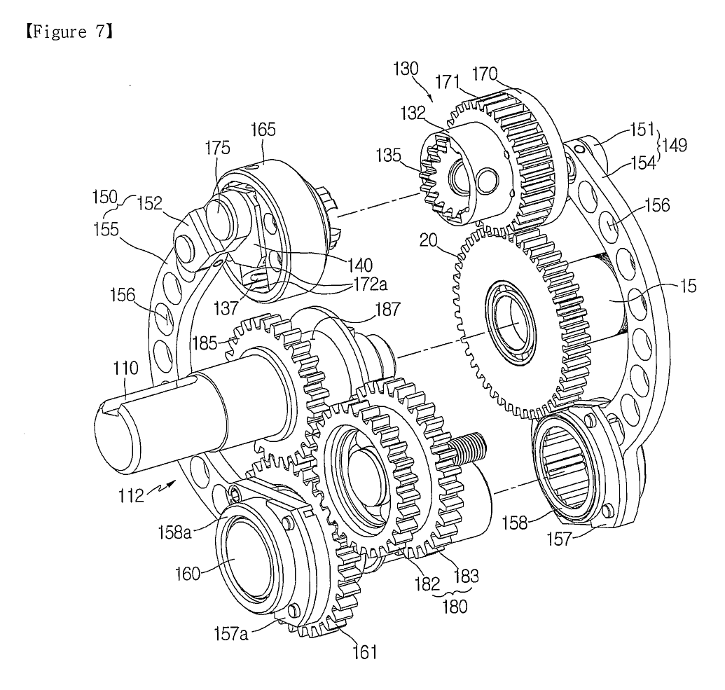

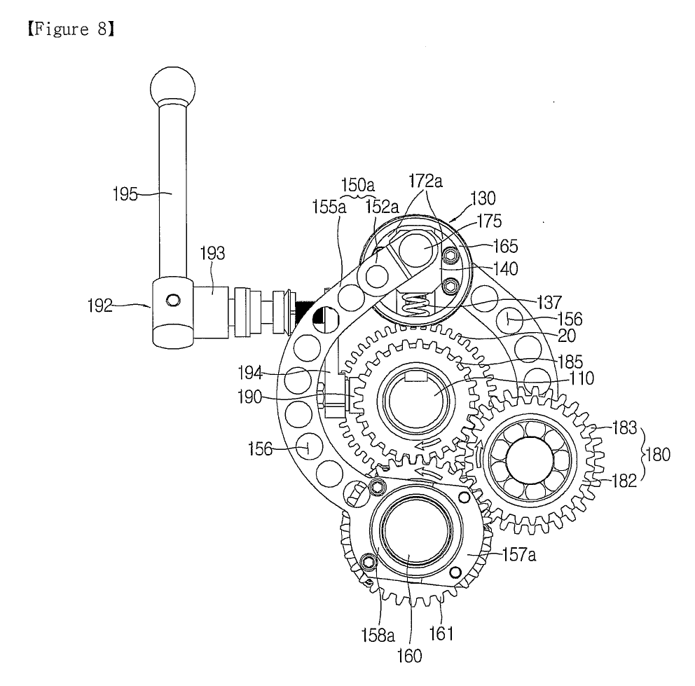

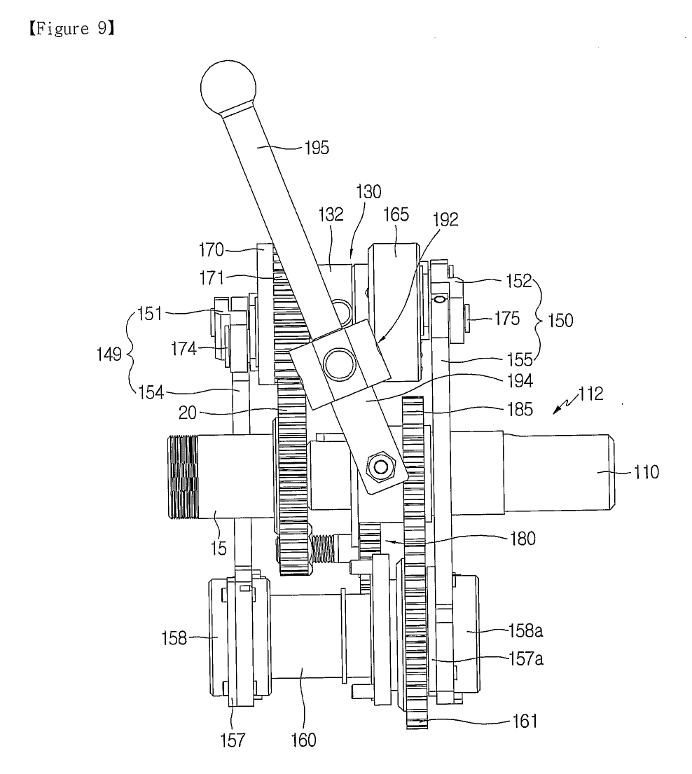

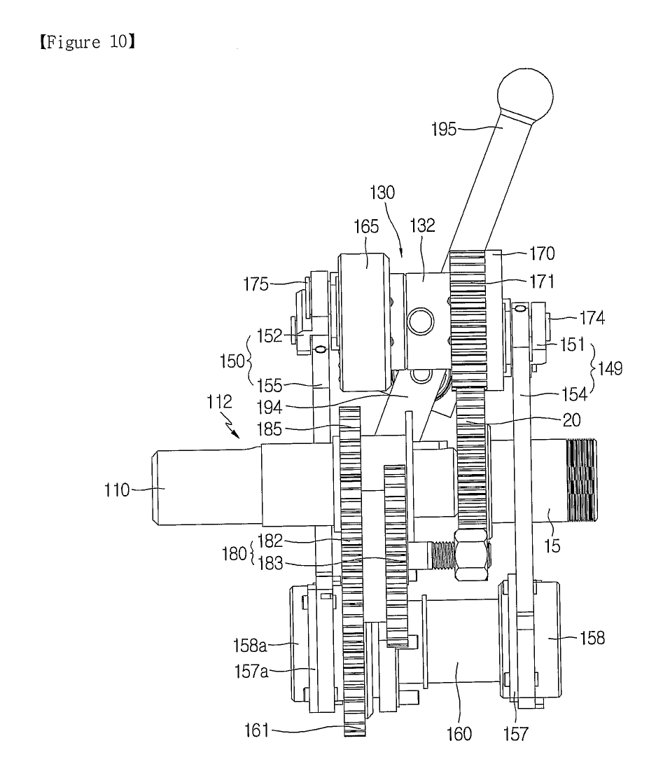

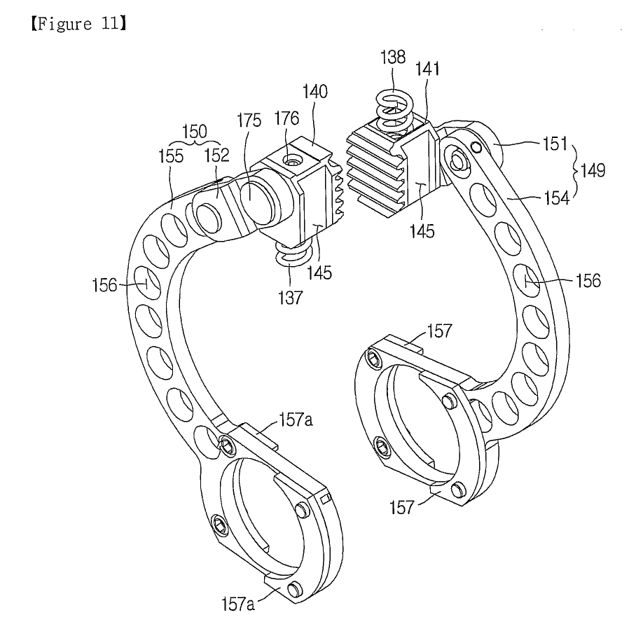

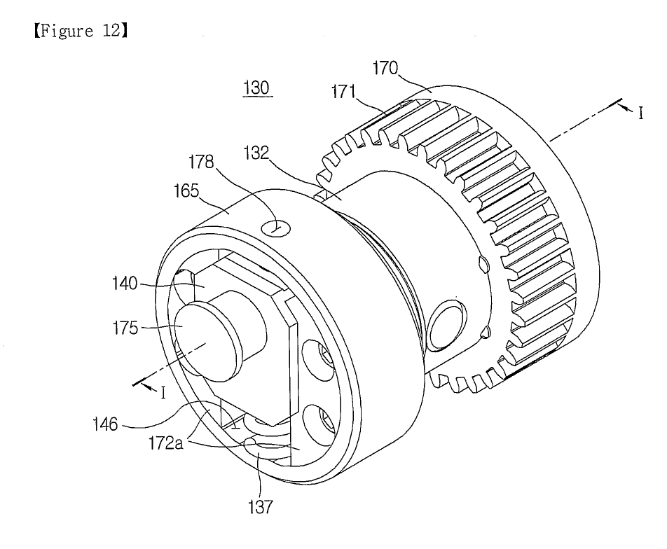

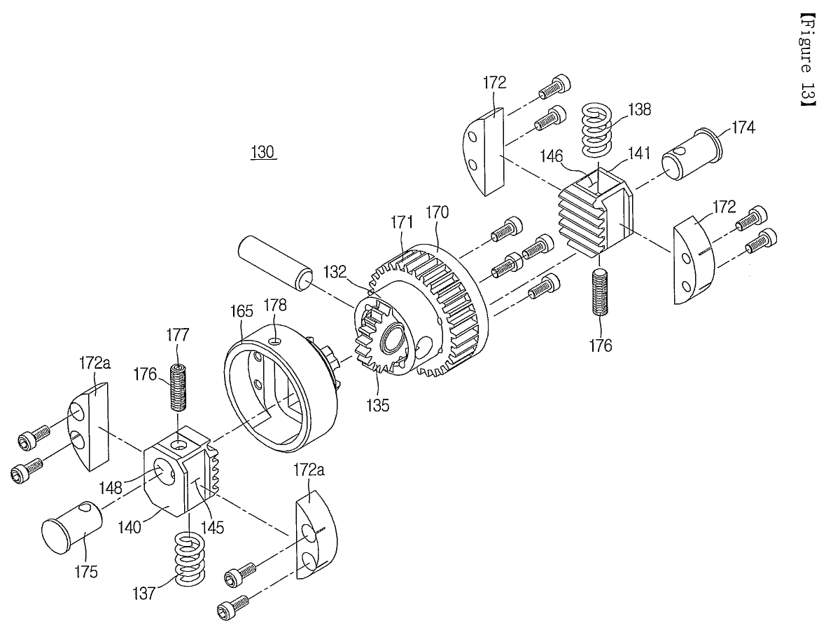

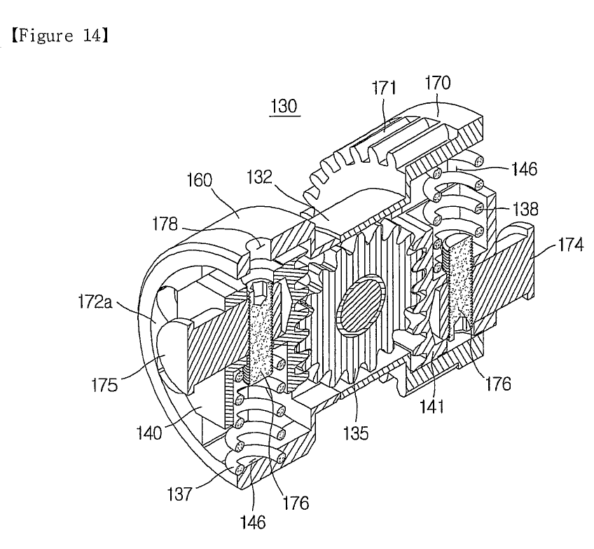

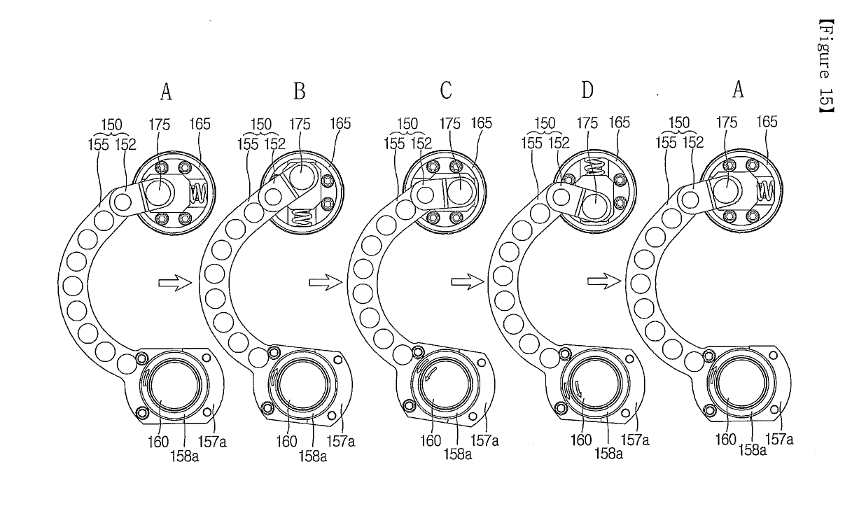

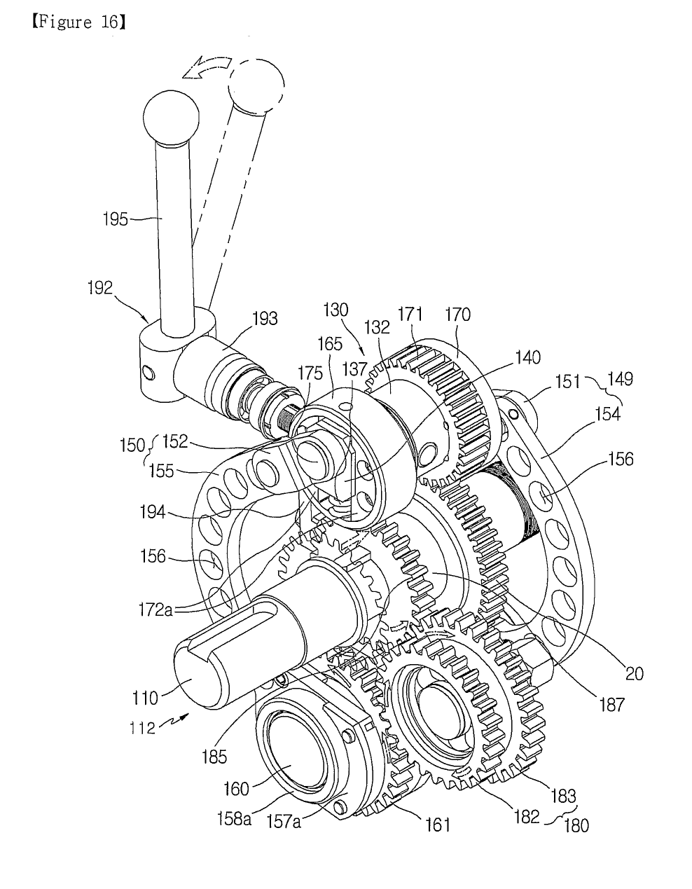

As illustrated in FIGS. 1 to 17, a continuously variable transmission suggested in the present invention includes a housing 100 to which an input shaft 15 is rotatably mounted to input power, an output section 112 outputting the power transferred from the input shaft 15 to the outside or receiving a load from outside, a torque change section 130 provided between the input shaft 15 and the output section 112 to change the torque of the power transferred from the input shaft 15 or the output section 112, and link devices 149 and 150 disposed between the output section 112 and the torque change section 130 and eccentrically connected to the torque change section 130 to transfer rotational power to the output section 112 or receive a load from the output section 112 by upward and downward reciprocal movements thereof.

In the continuously variable transmission, the housing 100 is divided by a fixed plate 105 provided in the interior thereof. An output shaft 110 of the output section 112 transferring power to the outside is engaged with a central portion of the fixed plate 105 and a lever shaft 132 of the torque change section 130 and a rotational shaft 160 are engaged with both sides of the fixed plate 105 respectively.

An input plate 115 is provided on one side of the housing 100 to rotatably insert the input shaft 15 of a power section 10 and an output plate 120 is provided on the other side thereof to rotatably insert the output shaft 110.

The input shaft 15 is connected to a power source such as a motor or an engine to transfer rotational power. The input shaft 15 is provided to a drive gear 20 to transfer the rotational power to the torque change section 130.

The torque change section 130 includes a lever shaft 132 rotatably mounted to the fixed plate 105 of the housing 100, a gear member 170 provided on one side of the lever shaft 132, to which the rotational power is transferred from the torque change section 130, and a circular member 165 provided on the other side of the lever shaft 132.

In the torque change section 130, the gear member 170 includes a driven gear 171 on the outer peripheral surface thereof and the driven gear 171 is enmeshed with a drive gear 20. Therefore, the rotational power can be transferred from the input shaft 15 to the torque change section 130.

A first rack gear 141 is movably mounted to the inner side of the gear member 170. The first rack gear 141 is resiliently supported by a first spring 138. Therefore, the first rack gear 141 is in a state in which it is supported by the first spring 138 and is moved to the outside of the center of the lever shaft 132.

More particularly, a linear groove 145 is formed in the interior of the gear member 170 and a pair of guide members 172 are engaged with the inner side of the linear groove 145. Therefore, the first rack gear 141 is slidably engaged with the guide members 172.

One side of the first spring 138 is inserted into a support recess 146 formed in the interior of the first rack gear 141 and the other side thereof is supported by the bottom surface of the interior of the gear member.

Therefore, the first spring 138 resiliently supports the first rack gear 141 radially outward.

The circular member 165 also has the same structure as the gear member 170 and the circular member 165 and the gear member 170 are symmetrically disposed with respect to the pinion gear 135.

That is, a second rack gear 140 is movably engaged with the inner side of the circular member 165. The second rack gear 140 is resiliently supported by the second spring 137. Therefore, the second rack gear 140 is in a state in which it is supported by the second spring 137 and is moved to the outside of the center of the lever shaft 132.

A linear groove 145 is formed in the interior of the circular member 1645 and a pair of guide members 172a are engaged with the inner side of the linear groove 145. Therefore, the second rack gear 140 is slidably engaged with the guide members 172a.

One side of the second spring 137 is inserted into a support recess formed in the interior of the second rack gear 140 and the other side thereof is supported by the bottom surface of the interior of the circular member 165.

Therefore, the second spring resiliently supports the second rack gear 140 radially outward.

The first and second rack gears 141 and 140 are connected to each other by the pinion gear 135. That is, when the first rack gear 141 is lifted, the second rack gear 140 is lowered by rotation of the pinion gear 135, and when the first rack gear 141 is lowered, the second rack gear 140 is lifted by rotation of the pinion gear 135.

Therefore, the first and second rack gears 141 and 140 can be moved by the pinion gear 135 by the same distance.

First and second rotation pins 174 and 175 respectively capable of engaging first and second rotary plates 151 and 152 of the link devices 149 and 150 with sides of the first and second rack gears 141 and 140 are respectively provided to the first and second rack gears 141 and 140.

First and second engaging recesses 148 are formed on inner surfaces of the first and second rack gears 141 and 140 respectively and the first and second rotation pins 174 and 175 are inserted into the engaging recesses 148 respectively.

Then, since the first and second engaging recesses 148 are formed so as to be deviated from the center of the lever shaft 132, the first and second rotation pins 174 and 175 inserted into the first and second engaging recesses 148 are also disposed so as to be deviated from each other.

As a result, when first and second arms 154 and 155 of the link devices 149 and 150 connected to the first and second rotation pins 174 and 175 are moved upward and downward, they have opposite phases.

Regulation screws 176 are provided to the rotation pins 174 and 175 of the first and second rack gears 140 and 141 to regulate the eccentric distances of the first and second rotation pins 174 and 175 from the center of rotation thereof.

The regulation screw 176 includes a head 177 and regulation holes 178 are formed in the circular member 165 and the gear member 170. The head 177 of the regulation screw 176 can be rotated by inserting a tool such as an Allen wrench into the regulation hole 178.

Therefore, when the regulation screw 176 is rotated, the first and second rotation pins 174 and 175 can be moved, and the eccentric distances of the first and second rack gears 140 and 141 respectively engaged with the first and second rotation pins 174 and 175 can be regulated as they are moved along the guide members 172 and 172a.

Meanwhile, the first and second arms 154 and 155 of the link devices 149 and 150 are connected to the first and second rotation pins 174 and 175 respectively and are moved upward and downward alternately when the torque change section 130 is driven to transfer the power to the power output section 112.

The link devices 149 and 150 include a first lever crank 149 and a second lever crank 150, and the first lever crank 149 and the second lever crank 150 have the same structure and are disposed symmetrically to each other.

More particularly, the first lever crank 149 includes a first rotary plate 151 connected to the first rotation pin 175 and a first arm 154, one side of which is hinge-coupled to the first rotary plate 151 and the other end of which is connected to the rotational shaft 160 of the power output section 112 to transfer power.

One side of the first rotary plate 151 is hinge-coupled to the first rotation pin 174 and the other side thereof is hinge-coupled to the first arm 154.

Therefore, when the first rotation pin 174 is rotated along a circular locus, the first arm 154 is moved along a vertically formed locus as the first rotary plate 151 is moved in association with the first rotation pin 174.

One side of the first arm 154 is connected to the first rotary plate 151 by means of the first rotation pin 174 and the other side thereof is connected to the rotational shaft 160 by means of an engaging plate 157.

The engaging plate 157 of the first arm 154 includes a one-way clutch in the interior thereof and the one-way clutch 158 is connected to the outer peripheral surface of the rotational shaft 160 rotatably engaged with the housing 100.

The second lever crank 150 also has the same structure as the first lever crank 149. In other words, the second lever crank 150 includes a second rotary plate 152 and a second arm 155.

An engaging plate 157a is provided on the other side of the second arm 155 and is provided with a one-way clutch 158a. Therefore, the second arm 155 is connected to the outer peripheral surface of the rotational shaft 160 by means of the one-way clutch 158a.

As mentioned above, the first and second lever cranks 149 and 150 are connected to the rotational shaft 160 by means of the one-way clutches 158 and 158a in the state in which they are disposed symmetrically to each other.

The first and second arms 154 and 155 can rotate the rotational shaft 160 as they are moved upward and downward alternately.

That is, when the first arm 154 is lowered by the power transferred from the torque change section 130, the one-way clutch 158 is rotated in the counterclockwise direction and the rotational shaft 160 is also rotated in the counterclockwise direction.

Then, since the second arm 155 is rotated in the clockwise direction, i.e. in a direction opposite to the first arm 154, the second one-way clutch 158a connected to the second arm 155 is rotated in the clockwise direction with respect to the rotational shaft 160 without transferring the power to the rotational shaft.

On the other hand, when the first arm 154 is lifted, the one-way clutch 158 is rotated in the clockwise direction without transferring the power to the rotational shaft.

Then, since the second arm 155 is rotated in the counterclockwise direction, i.e. in a direction opposite to the first arm 154, the second one-way clutch 158a connected to the second arm 155 rotates the rotational shaft 160 in the clockwise direction.

Consequently, the first and second arm 154 and 155 can rotate the rotational shaft 160 alternately.

Meanwhile, when the load of the output shaft 110 increases during the rotation of the rotational shaft 160, the rotational shaft 160 transfers the load to the torque change section 130 in the reverse direction by means of the first and second arms 154 and 155.

Then, the torque change section 130 increases the instantaneous torque for operating the first and second lever cranks 149 and 150.

Further, as the increased torque is transferred to the first and second rack gears 141 and 140, the first and second rack gears 141 and 140 press the first and second springs 137 and 138 respectively.

Therefore, the first and second rack gears 141 and 140 are moved toward the center of rotation of the lever shaft 132 along the guide member 172 to absorb the increased load.

If the load of the output shaft 110 increases further, the first and second rotation pins 174 and 175 of the first and second rack gears 140 and 141 are moved to the center of rotation of the lever shafts 132 to make the eccentric distance zero.

Therefore, since the first and second rotary plates 151 and 152 are located on the same line as the center of rotation of the lever shaft 132, even when the lever shaft 132 is rotated, the first and second rotary plates 151 and 152 are not rotated, not influencing the load to the power section 10.

On the other hand, when the load of the rotational shaft 160 returns to the original state or decreases, since the instantaneous torque capable of operating the first and second lever cranks 149 and 150 decreases, the first and second rack gears 140 and 141 return to their original position by the resilient forces of the springs 137 and 138.

Therefore, the torque change section 130 can perform a drive operation in a normal state.

Meanwhile, since the first and second arms 154 and 155 are preferably formed of carbon steel, they maintain the strength enough to transfer power from ends of the first and second arms 154 and 155 to the other ends thereof. Further, a plurality of through-holes 156 are formed in the first and second arms 154 and 155 to reduce the weight thereof.

Since the first and second arms 154 and 155 of the first and second lever cranks 149 and 150 are disposed symmetrically to each other, vibrations generated from the movements of the first and second arms 154 and 155 can be offset.

That is, the first and second arms 154 and 155 are fluctuated on both sides of the housing when the lever cranks 149 and 150 are moved, and they should be disposed symmetrically to each other so that the inertial moments of the first and second arms 154 and 155 with respect to the housing 100 can be balanced to prevent generation of vibrations due to eccentric concentration of the inertial moments.

Meanwhile, the output section 112 includes a rotational shaft 160 rotatably provided in the housing 100 and rotated in association with the link devices 149 and 150, first and second one-way clutches 158 and 158a provided at ends of the first and second arms 154 and 155 respectively to transfer rotational power to the rotational shaft 160 in one direction, an output shaft 110 outputting the rotational power transferred from the rotational shaft 160 to the outside, and direction conversion members 180 and 185 provided between the rotational shaft 160 and the output shaft 110 to convert the rotational direction of the output shaft to the forward or reverse direction.

Each of the direction conversion members 180 and 185 includes a medium gear 180 enmeshed with a rotary gear 161 of the rotational shaft 160 to selectively transfer the rotational power to the output shaft 110 and a change gear 185 movably engaged with the output shaft 110 and selectively enmeshed with the rotational shaft 160 or the medium gear 180 to change the rotational direction of the output shaft 110.

The medium gear 180 includes a front gear 182 always enmeshed with the rotary gear 161 of the rotational shaft 160 and a rear gear 183 connected to the rear side of the front gear 182 and enmeshed with the change gear 185 of the output shaft 110.

Therefore, when the change gear 185 moves forward along the output shaft 110 to be enmeshed with the rotary gear 161, since the rotation power of the rotary gear 161 rotated in the counterclockwise direction is transferred to the change gear 185, the change gear 185 can be rotated in the clockwise direction to rotate the output shaft 110 in the forward direction. Then, the front gear 182 is enmeshed with the rotary gear 161 and is in an idling state.

On the other hand, when the change gear 185 moves rearward along the output shaft 110 to be connected to the rear gear of the medium gear 180, since the rotational power of the rotary gear 161 rotated in the counterclockwise direction is transferred to the front gear 182, the front gear 182 is rotated in the clockwise direction. Further, when the front gear 182 is rotated in the clockwise direction, since the rear gear 183 is also rotated in the clockwise direction, the change gear 185 can be rotated in the counterclockwise direction (in the reverse direction).

As mentioned above, as the change gear 185 is moved forward or rearward along the output shaft 110, the output shaft 110 is rotated in the forward direction or in the reverse direction.

Further, a pressing device 192 is provided outside the housing 110 to move the change gear 185 forward and rearward.

The pressing device 192 includes a horizontal shaft 193 rotatably mounted to the housing 100, a vertical plate 194 vertically mounted to one side of the horizontal shaft 193, a knob 195 connected to the other side of the horizontal shaft 193, and a circular body 190 connected to the vertical plate 194 to move the change gear 185 forward and rearward.

The knob 195 is disposed outside the housing 100 to be easily rotated. The horizontal shaft 193 is rotated by rotating the knob 195 and the vertical plate 194 connected to the horizontal shaft 193 is also rotated. When the vertical plate 194 is rotated, the circular body is moved forward and rearward.

Then, the circular body 190 is inserted into a recess 187 formed in the change gear 185.

Therefore, when the knob 195 is pushed or pulled, the circular body 190 presses the inner wall of the recess 187 to move the change gear 185 forward or rearward.

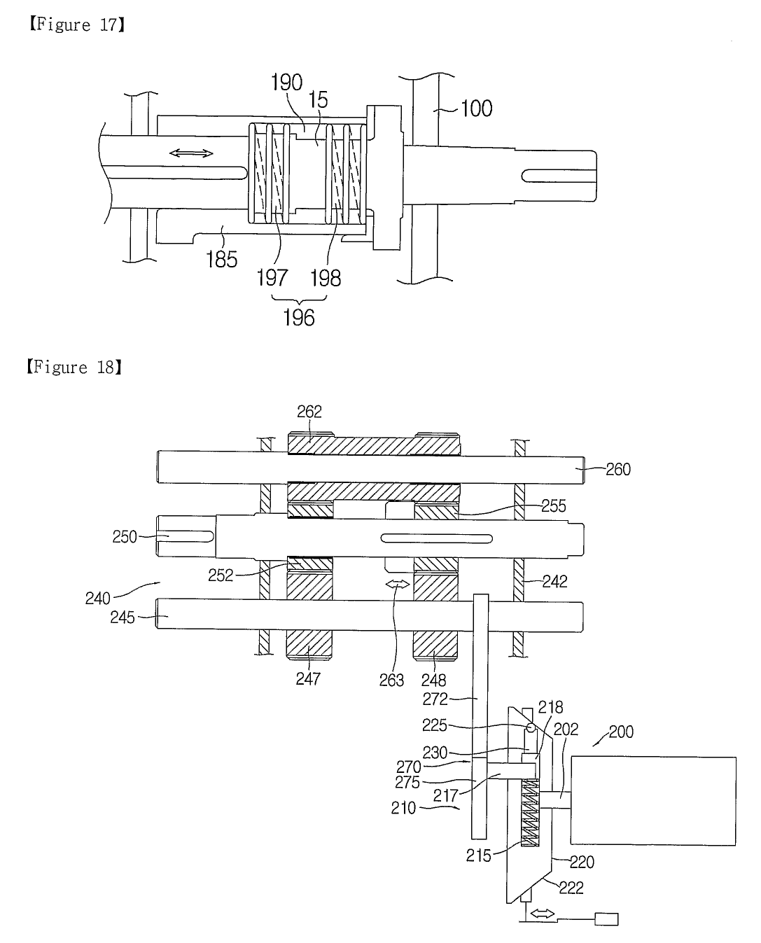

Meanwhile, as illustrated in FIG. 17, a resilient member 196 is provided in the pressing device 192 to more easily move the knob 195 forward and rearward.

The resilient member 196 includes a first resilient body 197 provided on the front side of the circular body 190 engaged with the input shaft 15 and a second resilient body 198 provided on the rear side of the circular body 190.

The first resilient body 197 resiliently supports the change gear 185 forward and the second resilient body 198 resiliently supports the resilient member 196 rearward.

Therefore, when the knob 195 is pushed forward for conversion of direction, the change gear 185 can be easily moved forward by the resilient force of the first resilient body 197.

On the other hand, when the knob 195 is pushed rearward, the change gear 185 can be easily moved rearward by the resilient force of the second resilient body 198.

In this way, since the pressing device 192 is resiliently supported by the resilient member 196, the conversion of forward and reverse rotation of the output shaft 110 can be easily accomplished.

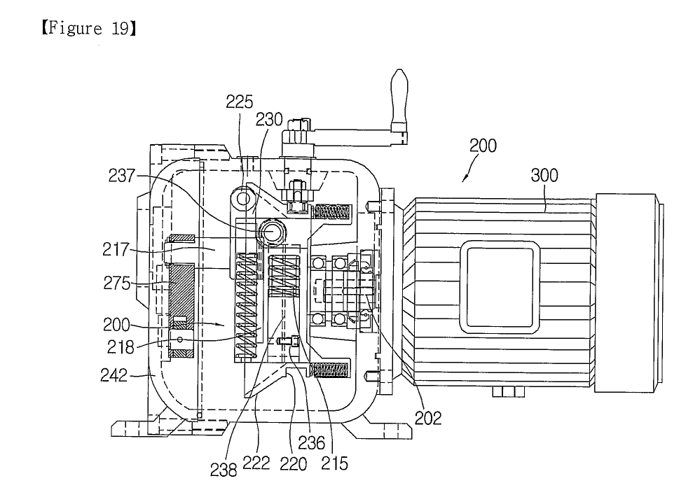

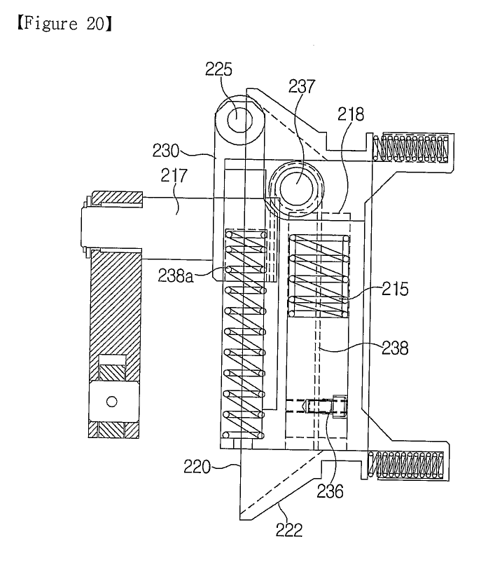

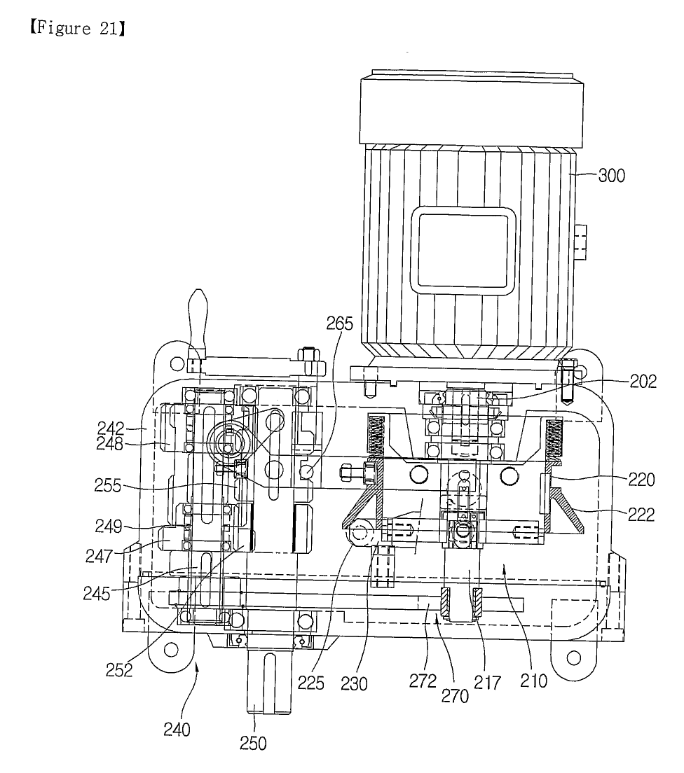

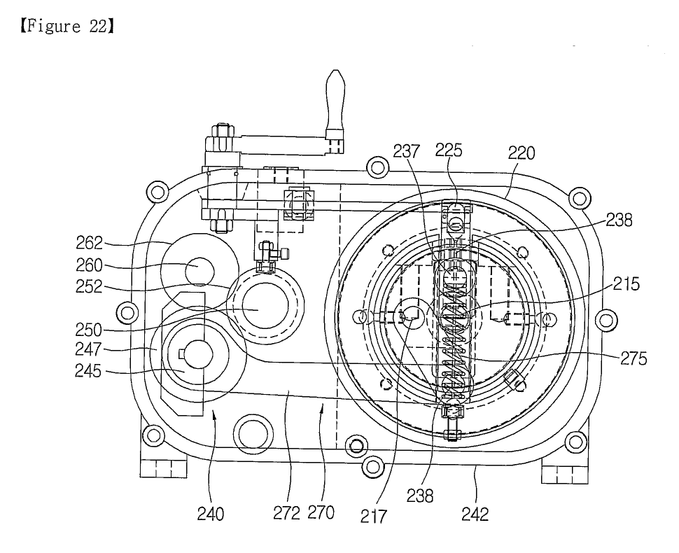

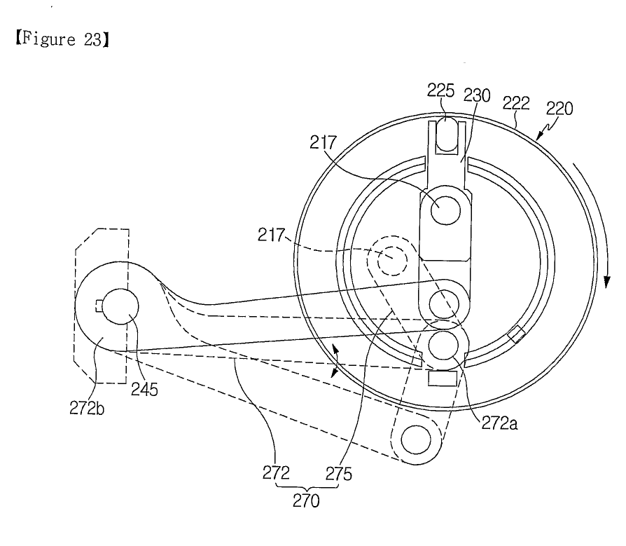

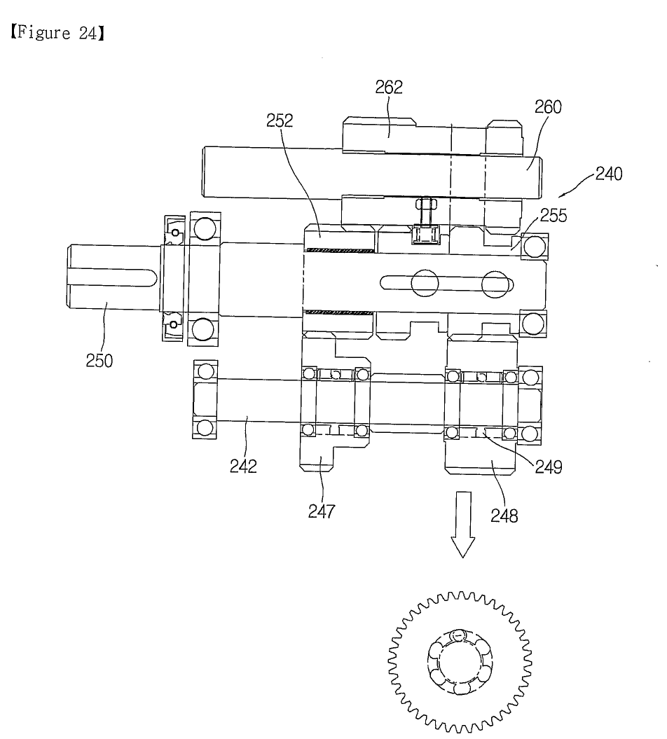

FIGS. 18 to 24 illustrate a continuously variable transmission according to another embodiment of the present invention. The continuously variable transmission according to this embodiment has a structure similar to the above-mentioned one and detailed description of the same elements will not be repeated.

As illustrated in FIGS. 18 to 24, the continuously variable transmission suggested in this embodiment of the present invention includes a housing 242 to which an input shaft 202 is rotatably mounted to input power, an output section 240 outputting the power transferred from the input shaft 202 to the outside or receiving a load from outside, a torque change section 210 provided between the input shaft 202 and the output section 240 to change the torque of the power transferred from the input shaft 202 or the output section 240, and a link device 270 disposed between the output section 240 and the torque change section 210 and eccentrically connected to the torque change section 210 to transfer rotational power to the output section 240 or receive a load from the output section 240 by upward and downward reciprocal movements thereof.

In the continuously variable transmission, the torque change section 210 is connected to the input shaft 202 transferring the power of a power section 300 such as a motor and an engine to the outside.

As the eccentric radius of the input shaft 202 is changed by a load applied from outside, a rotation pin 217 regulating the torque transferred from outside is connected to the input shaft 202. The rotation pin 217 is resiliently supported by a spring 215 on the front side of the input shaft 202, and when an external load is applied, the eccentric distance is regulated in the radial direction of the input shaft 202.

Then, the resilient device may be a resilient member to support the rotation pin 217 as well as the spring 215. For example, an air cylinder which can be resiliently compressed and then can return the rotation pin 217 to its original position may be employed as the resilient device.

The torque change section 210 is connected to the input shaft 202 of the power section 300 to be rotated, and a linear passage along which the rotation pin 217 is slid and in which the spring 215 is disposed is formed on the front side of the torque change section 210.

An inclined annular flange 222 is provided on the outer side of the linear passage 218 and the annular flange 222 is connected to a cylindrical torque change housing 220.

A roller 125 supported by the inner peripheral wall of the annular flange 222 is provided on one side of the torque change section 210 and a pressing pin 230 supported by the rotation pin 217 is provided on the other side thereof.

Then, the distance between the center lines of the rotation pins 217 and the torque change housing 220 can be regulated by linearly moving the torque change housing 220 and pressing the pressing pin 230 with the annular flange 222.

In the torque change section 210, when the torque change housing 220 is moved to the front side of the input shaft 202, the roller is moved to the rear side of the annular flange 222 along the inclined inner peripheral wall of the annular flange 222.

Then, as the pressing pin 230 is pressed and thus the pressing pin 230 presses the rotation pin 217, the spring 215 is compressed to reduce the eccentric distance of the rotation pin 217 so that the rotation pin 217 is close to the center line of the input shaft 202.

Therefore, after fixing the torque change housing 220, the eccentric radius of the rotation pin 217 with respect to the input shaft 202 can be fixed.

Then, when the external load continuously increases, the rotation pin 217 should be maximally moved to a position of the linear passage 218 of the torque change housing 220, and since the eccentric distance of the rotation pin 217 from the center line of the input shaft 202 becomes zero, the rotation pin 217 is only rotated between the input shaft 202 and the link device 270.

Therefore, since the arm 272 of the link device 270 cannot be moved upward and downward, there exists no output transferred to the power output section 240 through the link device 270 and an external load transferred to the power section through the input shaft 202 becomes zero, thereby preventing an influence on the power section 200 due to the continuously increasing external load and protecting the power section 200 from an overload.

Further, the torque change housing 220 includes a rotational inertia regulation device to uniformly regulate the eccentrically concentrated mass distribution with respect to the center line of the input shaft 202.

In other words, since a balance weight 236 is disposed in the linear passage of the torque change housing 220, the eccentric distance can be regulated on the opposite side of the center line of the input shaft 202 in correspondence to the slide of the rotation pin.

The balance weight 236 makes the eccentrically concentrated mass distribution of the rotation pin 217 uniform to prevent generation of vibration of the torque change housing 220 due to the rotation pin 217 during the high speed rotation of the input shaft 202 and prevent generation of vibration of the input shaft 202, thereby preventing damage to a bearing of the input shaft 202.

Then, the balance weight 236 may be connected to a wire 238 wound on a winding roller 237 rotated by a horizontal movement of the torque change housing 220 or a soft linear member.

That is, the balance weight 236 is disposed on one lower side of winding roller 237 and is connected to one side of the wire 238 wound on the winding roller 237 and the other end 238a of the wire 238 is connected to a lower end portion of the pressing pin 230 disposed on the other lower side of the winding roller 237.

Therefore, the pressing pin is pressed by the inner surface of the annular flange 222 of the torque change housing 220 to be moved downward, and when the rotation pin 217 approaches the center line of the torque change housing 220 by the movement of the pressing pin 230, reducing the eccentric distance thereof from the input shaft 202, the other end 238a of the wire 238 is moved downward as the pressing pin 230 is lowered and the balance weight 236 connected to one side of the wire 238 is moved upward, thereby reducing the eccentric distance of the balance weight 236 from center line of the torque change housing 220.

Meanwhile, as the torque change housing 220 is moved to the rear side of the input shaft 202, the roller 125 is moved to the front side of the annular flange 222 along the inclined inner peripheral wall of the annular flange 222. Further, the pressing pin 230 is loosened in the radial direction of the input shaft 202 by the pressing operation of the rotation pin 217 to which the resilient force of the spring 215 is applied, thereby increasing the eccentric distance of the rotation pin 217 from the input shaft 202.

That is, when the pressing pin 230 is loosened from the inner surface of the annular flange 222 of the torque change housing 220 to be moved upward, the rotation pin 217 becomes spaced apart from the center line of the torque change housing 220. Then, since the other end 238a of the wire 238 is moved upward, the length of the wire 238 from the winding roller 237, by which the balance weight is hung, is increased and the balance weight 236 becomes far away from the center line of the torque change housing 220 in correspondence to the rotation pin 217.

As mentioned above, since the wire 238 to which the balance weight 236 is connected is wound on or released from the winding roller 237 by regulating the eccentric distance of the rotation pin 217 regulated by the pressing pin 230 from the input shaft, the eccentric distance of the balance weight 236 from the input shaft 202 can be automatically regulated.

The link device 270 includes an arm 272 one end of which is fixed to a driven shaft 245 of the power output section to rotate the driven shaft 245 in the forward direction or in the reverse direction while reciprocally moving upward and downward.

One end of the link device 270 is connected to the rotation pin 217 revolving about the center of rotation of the torque change housing 220 and the other end thereof is connected to the arm 272.

Then, as the rotation pin 217 is rotated by the rotation of the torque change housing 220, the rotary plate 275 engaged with the rotation pin 217 is revolved around the center of rotation of the torque change housing 220 together with the rotation pin 217 and is also rotated about the rotation pin 217.

Therefore, a connecting portion 272a of the arm 272 connected to the rotation pin 217 is reciprocally moved to the upper and lower sides of the torque change housing 220. A fixed portion 272b of the arm fixed to the driven shaft 245 is fixed to the driven shaft 245 to be rotated in the forward direction or in the reverse direction and the driven shaft 245 is rotated forwardly and reversely as the fixed portion 272b of the arm 272 is rotated in the forward direction or in the reverse direction.

Then, the mechanism in which the rotational power of the power section 300 is transferred to the driven shaft 245 by the link device 270 is similar to a lever crank mechanism pertaining to a four bar linkage.

That is, the lever crank mechanism includes a first link as a fixed base, a second link one end of which is engaged with the first link, a third link one end of which is engaged with the other end of the second link, the third link existing in a space, and a fourth link one end of which is engaged with the other end of the second link, the other end of the fourth link being spaced apart from an engaged portion of the second link with the first link to be engaged with the first link.

In the lever crank mechanism, when the second link provided on one side of the base is rotated in the base, the fourth link connected to the second link by means of the third link is fluctuated.

Therefore, the first link is the fixed portion of the torque change housing 220 and the fixed portion of the driven shaft 245, the second link corresponds to the torque change housing 220 and the rotation pin 217, the third link corresponds to the rotary plate 275, and the fourth link corresponds to the arm 272.

Since the link device 270 has a mechanism similar to the lever crank mechanism having a four bar linkage, the rotary plate 275 may be eliminated and may be replaced by a link mechanism engaged with a slide passage which can be formed in the arm 272.

Then, the slide passage is formed linearly at an end of the arm 272 and an end of the rotation pin 217 is connected to the slide passage.

Meanwhile, the output section 240 includes a case 242 fixed to the power section 200. In the case, the driven shaft 245 and the output shaft 250 are disposed in parallel to the input shaft 202 and an upper shaft 260 is disposed between the driven shaft 245 and the output shaft 250.

The driven shaft 245 includes a one-way clutch 249 and thus is idled in one direction and is rotated in the other direction together with the driven shaft 245. First and second clutch teeth 247 and 248 are mounted to the outer periphery of the driven shaft 245.

The first clutch tooth 247 is located on the left side of the driven shaft 245 and is rotated together with the driven shaft 245 by the clockwise rotation of the driven shaft 245 transferred from the torque change section 210 to the driven shaft 245. Further, the driven shaft 245 can be idled in the counterclockwise direction by the one-way clutch 249.

The second clutch tooth 248 is located on the right side of the driven shaft 245 and is rotated together with the driven shaft 245 by the counterclockwise rotation of the driven shaft 245 transferred to the driven shaft 245 in contrast to the first clutch tooth 247. Further, the driven shaft 245 can be idled in the clockwise direction by the one-way clutch 249.

Then, the clutch bearing 249 is rotated in one direction on a shaft and is rotated together with the shaft in the other direction.

The case 242 is provided with a rotary tooth 252 coupled to the output shaft 250 to be idled and enmeshed with the first clutch tooth 247, a movable tooth 255 slid from the output shaft 250 to be enmeshed with or separated form the second clutch tooth 248, and a fixed tooth 262 fixed to the upper shaft 260, the left side of which is enmeshed with the rotary tooth 252 and the right side of which is enmeshed with the second clutch tooth 248.

Then, the movable tooth 255 is provided in the output shaft 250 so as to be rotated together with the output shaft 250 or to be slid from the output shaft 250.

A movement device 263 of the movable tooth 255 fixes one side of the movable tooth 255 which is allowed by a ring member 265 capable of rotating the movable tooth 255. Then, the ring member 265 can include a handle 167 for movement of the ring member 265.

Here, the structure in which the movable tooth 255 is moved along the output shaft 250 can have various structures as well as the simple structure such as the ring member 265 and the handle 267. For example, the structure can be automatically realized by an actuator such as a linear motor, a cylinder, and a step motor.

Then, the movable tooth 255 is moved to the left side of the output shaft 250 to be enmeshed with the fixed tooth 262 and is moved to the right side to be enmeshed with the second clutch tooth 248, and the second clutch tooth 248 is enmeshed with the left side of the fixed tooth 262 to be rotated.

Hereinafter, the operation of the continuously variable transmission according to the second embodiment of the present invention will be described in detail.

First, if the shaft is rotated by applying a power source to the power section 300, the rotational power of the power section 300 rotates the torque change section 210. The rotation pin 217 of the torque change section 210 is rotated eccentrically from the center line of the torque change section 210 and the rotary plate 275 is rotated by the rotation of the rotation pin 217.

Therefore, the arm 272 is reciprocally moved upward and downward to rotate the driven shaft 245 in the forward direction or in the reverse direction.

Then, when the driven shaft 245 is rotated in the clockwise direction, i.e. in the forward direction by the arm 272, the first clutch tooth 247 is rotated together with the driven shaft 245 by the clockwise rotation of the driven shaft 245.

The rotation of the first clutch tooth 247 idles the rotary tooth 252 engaged with the output shaft 250 by means of the bearing in the counterclockwise direction, i.e. the reverse direction and the rotation of the rotary tooth 252 rotates the fixed tooth 262 of the upper shaft 260 in the forward direction.

Here, since the fixed tooth 262 is enmeshed with the second clutch tooth 248 of the driven shaft 245, it rotates the second clutch tooth 248 in the reverse direction.

Then, the reverse rotation of the second clutch tooth 248 is an idling operation in which the driven shaft 245 is not rotated and the second clutch tooth 248 transfers the rotational power to the output shaft 250 and is enmeshed with the movable tooth 255 located at the left end of the output shaft 250.

Therefore, the movable tooth 255 is rotated in the forward direction and the forward rotation of the movable tooth 255 rotates the output shaft 250 in the forward direction.

On the other hand, when the driven shaft 245 is rotated in the counterclockwise direction, i.e. in the reverse direction by the arm 272, the first clutch tooth 247 of the driven shaft 245 is idled and the second clutch tooth 248 is rotated in the reverse direction together with the driven shaft 245.

Then, since the second clutch tooth 248 is enmeshed with the movable tooth 255 of the output shaft 250, the movable tooth 255 is rotated in the forward direction and the output shaft 250 is rotated in the forward direction.

The reverse rotational power of the second clutch tooth 248 is transferred to the fixed tooth 262 to rotate the fixed tooth 262 in the forward direction. Further, the fixed tooth 262 rotates the rotary tooth 252 in the reverse direction and the rotary tooth 252 rotates the first clutch tooth 247 in the forward direction.

Therefore, the forward rotation of the first clutch tooth 247 is idled by the clutch bearing 249 on the driven shaft 245.

The above description is about the case in which the movable tooth 255 is located at the right end of the output shaft 250 and relates to an output by which the output shaft 250 is rotated in the forward direction by the forward and reverse rotation of the driven shaft 245 by the upward and downward reciprocal movement of the arm 272.

On the other hand, when the movable tooth 255 is moved from the right end of the output shaft 250 to the right side, the movable tooth 255 is separated from the second clutch tooth 248 and is enmeshed with the left side of the fixing tooth 262. Therefore, the output shaft 250 can be rotated in the reverse direction by the forward rotation of the driven shaft 245 due to the arm 272.

That is, the driven shaft 245 is rotated in the forward direction and the first clutch tooth 247 is rotated in the forward direction, and then the rotary tooth 252 is rotated in the reverse direction by the first clutch tooth 247.

The fixed tooth 262 is rotated in the forward direction by the rotary tooth 252 and the movable tooth 255 is rotated in the reverse direction by the fixing tooth 262, and the output shaft 250 is rotated in the reverse direction by the movable tooth 255.

Meanwhile, since the second clutch 248 is enmeshed with the fixed tooth 262, it is rotated in the reverse direction by the forward rotation of the fixed tooth 262. Then, since the reverse rotation of the second clutch tooth 248 is an idling operation in the driven shaft 245, it does not influence the forward rotation of the driven shaft 245.

Further, when the driven shaft 245 is rotated in the reverse direction by the arm 272, the first clutch tooth 247 is idled and the second clutch tooth 248 is rotated in the reverse direction together with the driven shaft 245.

Therefore, the fixed tooth 262 is rotated in the forward direction by the second clutch tooth 248 and the movable tooth 255 is rotated in the reverse direction by the second clutch tooth 248, and the output shaft 250 is rotated in the reverse direction by the movable tooth 255.

Then, the forward rotation of the fixed tooth 262 rotates the rotary tooth 252 in the reverse direction and the first clutch tooth 247 is rotated in the forward direction by the rotary tooth 252.

Therefore, since the forward rotation of the first clutch tooth 247 is an idling operation in the driven shaft 245, it does not influence the reverse rotation of the driven shaft 245.

As mentioned above, the forward and reverse rotation of the output shaft 250 can be selectively changed by the position of the movable tooth 255, and the power of the power section 300 is transferred to the outside through the output shaft 250.

Meanwhile, when the output shaft 250 transfers power to an industrial machine, a load changed at the initial stage of the operation of the industrial machine or by a change of the load applied to the industrial machine itself is applied to the output shaft 250.

Then, as the load of the output shaft 250 increases, the load of the driven shaft 245 transferring the rotational power to the output shaft 250 increases and the load transferred to the arm 272 rotating the driven shaft in the forward direction and in the reverse direction also increases.

Further, as the load of the arm 272 increases, the load transferred to the rotary plate 275 connected to the arm 272 increases.

As the load of the rotary plate 275 increases, the load of the rotary pin 217 engaged with the rotary plate 275 increases, and as the load of the rotation pin 217 increases, the rotation pin 217 is supported by the spring and the load of the eccentrically disposed torque change housing 220 increases.

As the load of the torque change housing 220 increases, since the load of the input shaft 202 rotating the torque change housing 220 increases, the load of the power section 300 rotating the input shaft 202 increases.

Then, the load increased in the rotary plate 275 is not transferred to the power section as it is and is applied as a force pressing the rotation pin 217 which can be moved radially from the center line of the torque change housing 220.

Therefore, the rotation pin 217 moves the spring to the center line of the torque change housing 220, compressing the spring 215.

That is, the rotation pin 217 is moved toward the center line of the input shaft 202 of the power section 300 while compressing the spring 215 and the eccentric distance of the rotation pin 217 from the center line of the input shaft 202 is reduced.

Therefore, the instantaneous torque of the rotation pin 217 transferred to the input shaft 202 of the power section 300 is reduced and the load of the power section 300 does not increase and maintains the original state.

Since after the load of the output shaft 250 increases, the instantaneous torque applied to the rotation pin 217 by the input shaft 202 of the power section 300 is reduced and the load of the power section 300 does not increase, and the rotational speed of the rotation pin 217 is not reduced and maintains the original state.

Further, the upward and downward displacement of the arm 272 is reduced since the radius of rotation of the rotation pin 217 is reduced.

As mentioned above, the principle of preventing an overload of the motor by increasing the load of the output shaft 250 and changing the radius of rotation of the rotation pin 217 is the principle relating to the rotational energy conservation law in which the radius of rotation of the rotation pin 217 is reduced by increasing the load of the output shaft 250 and the forward and reverse rotation angle of the driven shaft 245 and the output rotational speed of the output shaft 250 are reduced by reducing the displacement of the arm 272 to increase the instantaneous torque of the output shaft 250.

Here, the rotational energy corresponding to the power of the power section 200 and the output generated in the power section 300 is not changed by the change of the load and the displacement of the arm 272 due to the change in the position of the rotation pin 217 is regulated in the torque change section 210.

Therefore, when the load of the output shaft 250 increases, the rotational speed of the output shaft 250 is reduced and the output torque of the output shaft 250 increases, and when the load of the output shaft 250 is reduced, the rotational speed of the output shaft 250 increases and the output torque of the output shaft 250 is reduced.

In other words, since the overload increasing the output torque of the power section 300 is not transferred to the power section 300 even when the load of the output shaft 250 is changed to an overload, the safe operation of the power section 300 can be secured.

The present invention relates to a continuously variable transmission, and more particularly to a continuously variable transmission capable of automatically increasing or decreasing an instantaneous torque output as a load applied to an output shaft increases or decreases. Industrial Applicability

The present invention relates to a continuously variable transmission, and more particularly to a continuously variable transmission capable of automatically increasing or decreasing an instantaneous torque output as a load applied to an output shaft increases or decreases. Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

1. A continuously variable transmission comprising:
a housing to which an input shaft is rotatably mounted to input power;
an output section outputting the power transferred from the input shaft to the outside or receiving a load from outside;
a torque change section provided between the input shaft and the output section to change the torque of the power transferred from the input shaft or the output section; and
a link device disposed between the output section and the torque change section and eccentrically connected to the torque change section to transfer rotational power to the output section or receive a load from the output section by upward and downward reciprocal movements thereof.

2. The continuously variable transmission according to claim 1, wherein the torque change section comprises:
a lever shaft rotatably mounted to the housing to transfer the rotational power to the link device;
a gear member engaged with one side of the lever shaft and enmeshed with the input shaft to transfer the rotational power; and
a circular member engaged with the other side of the lever shaft, to which the rotational power of the gear member is transferred.

3. The continuously variable transmission according to claim 2, wherein the circular member or the gear member comprises:
first and second guide members provided in the interior thereof;
first and second rack gears slidably engaged with the interior of the first and second guide members respectively;
first and second springs pressing the first and second rack gears radially outward by resiliently supporting the first and second rack gears respectively;
a pinion gear provided between the first and second rack gears; and
first and second rotation pins respectively provided on the outer surfaces of the first and second rack gears.

4. The continuously variable transmission according to claim 3, wherein the eccentric distance of the rack gear from the center of rotation of the lever shaft is regulated by screw-coupling a regulation screw to the rack gear.

5. The continuously variable transmission according to claim 2, wherein the link device comprises:
a first rotary plate connected to a first rotation pin of the first rack;
a first arm one side of which is hinge-coupled to the first rotary plate and the other side of which is connected to the output section to transfer power;
a second rotary plate connected to a second rotation pin of the second rack; and
a second arm one side of which is hinge-coupled to the second rotary plate and the other side of which is connected to the output section to transfer power.

6. The continuously variable transmission according to claim 5, wherein the first arm and the second arm are disposed symmetrically to each other.

7. The continuously variable transmission according to claim 5, wherein the output section comprises:
an output side rotatably provided in the housing;
first and second one-way clutches provided at ends of the first arm and the second arm respectively to transfer the rotational power to the output shaft in one direction; and
a direction conversion member provided between the rotational shaft and the output shaft to convert the rotational direction of the output shaft to the forward or reverse direction.

8. The continuously variable transmission according to claim 7, wherein the direction conversion member comprises a medium gear provided between the rotational shaft and the output shaft to selectively transfer the rotational power to the output shaft and a change gear movably engaged with the output shaft and selectively enmeshed with the rotary gear of the rotational shaft or the medium gear to convert the rotational direction of the output shaft.

9. The continuously variable transmission according to claim 8, wherein the medium gear comprises a front gear always engaged with the rotary gear of the rotational shaft and a rear gear connected to the rear side of the front gear and enmeshed with the change gear of the output shaft.

10. The continuously variable transmission according to claim 8, wherein the housing further comprises a pressing device, and the pressing device comprises:
a horizontal shaft rotatably mounted to the housing;
a vertical plate vertically mounted to one side of the horizontal shaft;
a knob connected to the other side of the horizontal shaft; and
a circular body connected to the vertical plate to move the change gear forward and rearward.

11. The continuously variable transmission according to claim 8, wherein the pressing device further comprises a resilient member, and the resilient member comprises a first resilient body provided on the front side of the circular body engaged with the drive shaft to press the change gear forward and a second resilient body provided on the rear side of the circular body to press the change gear rearward.

12. The continuously variable transmission according to claim 1, wherein the torque change section comprises:
a rotation pin connected to the input shaft to be eccentrically rotated;
an inclined torque change housing capable of absorbing a load as the rotation pin is moved in a rolling state; and
a pressing pin one end of which is engaged with a roller supported by the inner peripheral wall of the torque change housing and the other end of which is supported by the rotation pin.

13. The continuously variable transmission according to claim 12, wherein the torque change housing comprises a linear passage provided on the front side thereof, in which a spring is disposed, and an inclined annular flange provided at an outskirt portion of the front side thereof.

14. The continuously variable transmission according to claim 12, wherein the torque change housing further comprises a rotational inertia regulation device to uniformly regulate mass distribution of the rotation pin or the torque change housing which is eccentrically concentrated with respect to the center line of the rotational shaft.

15. The continuously variable transmission according to claim 14, wherein the rotational inertia regulation device is a balance weight.

16. The continuously variable transmission according to claim 12, wherein the output section comprises:
a driven shaft to which power is transferred from the rotation pin;
a drive shaft disposed in parallel to the driven shaft to output power;
a pair of clutch teeth provided in the driven shaft to transfer rotational power only in one direction by a one-way clutch;
a rotary tooth engaged with the drive shaft and enmeshed with one of the pair of clutch teeth;
a movable tooth slid from the drive shaft and enmeshed with or separated form one of the clutch teeth; and
a fixed tooth fixed to the upper shaft, one side of which is enmeshed with the rotary tooth and the other side of which is enmeshed with one of the clutch teeth.

17. The continuously variable transmission according to claim 16, wherein the link device comprises an arm connected to the driven shaft of the power output section and a rotary plate one side of which is connected to the arm and the other side of which is connected to the rotation pin.
